(19) United States
(12) Patent Application Publication
(10) Pub. No.: US 2012/0264088 A1
(43) Pub. Date: Oct. 18, 2012

(54) MAKEUP PRACTICE BOOK

(76) Inventors: Alina Livne, Misgav (IL); Yael Zimet-Rubner, Shoham (IL)

(21) Appl. No.: 13/086,492

(22) Filed: Apr. 14, 2011

(51) Int. Cl. G09B 19/00

(52) U.S. Cl. 434/100

(57) ABSTRACT

A makeup practice book includes a three-dimensional model mounted on a bound page of the book, the model including a surface to which a makeup substance may be applied. At least one compartment for holding a makeup substance that may be applied to the surface is provided on a bound page of the book. Each page of one or more bound pages adjacent to the page on which the model is mounted includes a cutout section that is aligned to the model, such that the surface is accessible via the cutout section when the book is open to a page of the adjacent bound pages.

### FIELD OF THE INVENTION

The present invention relates to books. More particularly, the present invention relates to a makeup practice book that includes a three dimensional model for practicing the application of makeup.

### BACKGROUND OF THE INVENTION

Interactive books combine printed material, such as a story, narrative, description, lesson, or instructions, with an object that may be manipulated. Manipulable objects in the various interactive books may be designed to serve one or more purposes. For example, a manipulable object may be added to a book for the purpose of holding a child's attention while reading or being read to. In other cases, the manipulable object may be designed to enhance a child's or an adult's enjoyment of the book. The manipulable object may also encourage cooperation among members of group that is reading the book. An interactive element may serve an educational purpose. In some cases, a manipulable object may be utilized as an enhanced visual aid, offering hands-on manipulation of an article related to the subject matter being learned. The hands-on manipulation may be in addition to subject matter presented in a verbal or visual manner. Such manual interaction or manipulation may be intended to enhance understanding or retention of the learned material. In other cases, the interactive element may serve as a built-in object on which to practice techniques learned in the book. Interactive books have been described, for example, by Cole et al. (U.S. Pat. No. 6,929,526), Vap (U.S. Pat. No. 5,915,729), Peters (U.S. Pat. No. 6,109,921), and Chamberlin (U.S. Pat. No. 3,918,180).

Mannequins and similar models of human heads may be utilized in learning or practicing various cosmetic techniques. Cosmetic techniques that are amenable to such use of models include hairdressing and makeup application. Such practice models have been described, for example, by Yau (U.S. Pat. No. 6,109,921) and by Simmons et al. (WO 2010/001164). Cosmetics kits, which include a variety of cosmetic substances, have been described, for example, by Mills (US 2010/0132734).

### SUMMARY OF THE INVENTION

There is thus provided, in accordance with some embodiments of the present invention, a makeup practice book including: a three-dimensional model extending from a bound page of the book, the model including a surface to which a makeup substance may be applied; at least one compartment for holding a makeup substance that may be applied to the surface, the compartment being mounted to a bound page of the book; and a plurality of bound pages adjacent to the page from which the model extends, each page of the plurality of bound pages including a cutout section that is aligned to the model, such that the model is accessible via the cutout section when the book is open to a page of the plurality of bound pages.

Furthermore, in accordance with some embodiments of the present invention, the page from which the model extends or to which the compartment is mounted is a cover of the book.

Furthermore, in accordance with some embodiments of the present invention, the cover is a back cover.

Furthermore, in accordance with some embodiments of the present invention, at least one of the following is removable and attachable: a bound page of the book, the model, the surface, and the compartment.

Furthermore, in accordance with some embodiments of the present invention, the model depicts a human face.

Furthermore, in accordance with some embodiments of the present invention, the surface includes a polymer material.

Furthermore, in accordance with some embodiments of the present invention, the book includes a compartment for holding a makeup applicator, the compartment being mounted to a bound page of the book.

Furthermore, in accordance with some embodiments of the present invention, the three dimensional model comprises a material selected from a group of materials consisting of: plastic, polymer, plaster, ceramics, glass, metal, cardboard, paper, wood and wood products.

Furthermore, in accordance with some embodiments of the present invention, the three dimensional model is produced by a technique selected from a group of techniques consisting of: three dimensional printing, die casting, molding, and laser cutting.

Furthermore, in accordance with some embodiments of the present invention, the plurality of bound pages is sufficiently thick, and the cutout section of each page of the plurality of bound pages is of such size and shape, so as to enable the book to close completely.

Furthermore, in accordance with some embodiments of the present invention, the book includes another three dimensional model that extends from a page of the plurality of bound pages, the other model including a cavity such that when the book is closed, at least a portion of the three dimensional model extends into the cavity of the other model.

Furthermore, in accordance with some embodiments of the present invention, the page from which the other model extends is a divider of the book.

Furthermore, in accordance with some embodiments of the present invention, book is part of a kit.

Furthermore, in accordance with some embodiments of the present invention, the kit includes an additional component selected from a group of kit components consisting of: a three-dimensional model, a compartment, makeup removal equipment, a page, a carrying case, an instruction book, and a data storage medium.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 shows a makeup practice book, in accordance with an embodiment of the invention, with the book closed and its front cover visible.

FIG. 2 shows the makeup practice book shown in FIG. 1 with the front cover opened.

FIG. 3 shows the makeup practice book shown in FIG. 1, opened to the inside of the back cover.

FIG. 4 shows a cross section of a makeup practice book that includes nested three-dimensional models, in accordance with an embodiment of the invention.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, or units have not been described in detail so as not to obscure the invention.

In accordance with some embodiments of the present invention, a makeup practice book incorporates a built-in three-dimensional model, and a built-in makeup kit or makeup compartments. Hereinafter in this description, a collection of individual makeup compartments may be referred to a makeup kit, whether or not the compartments are transportable, removable, or replaceable as a single unit.

The three-dimensional model and makeup kit are mounted to one of the pages of the book (where page may be understood as including the front and the back covers, as well as any internal dividers). The pages to which the three-dimensional model and makeup kit are mounted are typically rigid (e.g. in the form of a hard cover or stiffened divider). For example, the three-dimensional model and the makeup kit may be mounted to the inside of a cover (e.g. the back cover) of the makeup practice book.

Pages of an adjacent block of pages of the makeup practice book (e.g. all pages, including the front cover, that precede the back cover to which the three-dimensional model and the makeup kit are mounted) include appropriately shaped and aligned cutout sections. When pages of the block are closed over the three-dimensional model and the makeup kit, the three-dimensional model and the makeup kit are accessible via the cutout sections. The model may extend through the cutout sections of the block of adjacent pages. Thus, when the book is opened, a user may apply makeup from the makeup kit to the three-dimensional model in accordance with instructions printed on interior pages of the book.

The cutout sections also prevent the three-dimensional model and the makeup kit from interfering with closing the book. The block of pages that include cutout sections is sufficiently thick so as to enable the book to close completely, such that all pages of the closed book lie atop (or adjacent to) one another. For example, if the three-dimensional model is mounted on the back cover, the height of the three-dimensional model may be greater than the thickness of the other pages, including the front cover. In order for such a book to close completely, all of the pages that precede the back cover, including the front cover, must include appropriately shaped and aligned cutout sections.

Alternatively or in addition to mounting on a cover, a three-dimensional model and the makeup kit may be mounted on an inner page such as divider placed between two groups of pages of the book. The three-dimensional model and the makeup kit may be mounted on separate pages, dividers, or covers. Various components of the makeup kit may be mounted on separate pages. Typically, the page or divider on which the three-dimensional model or the makeup kit is mounted is stiffened to enable firm mounting of the three-dimensional model or makeup kit without tearing the page.

Two or more separate three-dimensional models may be mounted on a single page. In this case, either a single cutout section on the adjacent pages may be made large enough to accommodate all of the three-dimensional models. Alternatively, separate cutout sections may be provided for at least some of the separate three-dimensional models.

In accordance with some embodiments of the present invention, different three-dimensional models or makeup kits may be mounted at different points of a suitable thick book. The pages between the different three-dimensional models and the different makeup kit may be provided with suitably placed cutout sections such that one three-dimensional model or makeup kit is accessible from each page of the makeup practice book. For example, a first three-dimensional model may be mounted to a divider in the center of the book, and a second three-dimensional model may be mounted inside the back cover. In this case, cutout sections in the first half of the book may enable access to the first three-dimensional model only, and cutout sections in the second half of the book may enable access to the second three-dimensional model only.

The three-dimensional model is typically in the form of a human face. The specific form of the human face of the three-dimensional model may be adapted to a particular purpose. For example, the form of the human face of the three-dimensional model may be adapted to match a described or illustrated face of a character in a story that is printed in the book.

The form of the face may be customized (e.g. by application of a three dimensional model fabrication technique on the basis of one or more photographs, e.g. by casting or molding, or by laser cutting) to match the face of a particular person. For example, the three-dimensional model may be in the form of a featureless generic face shape. The generic face shape may be overlain with an outer cover that is designed to match a particular face. The outer cover may be made of a flexible material resembling human skin in its texture. For example, the customized face may be that of the person purchasing the makeup practice book, of an intended recipient of a makeup practice book, or of a publicly known or historical figure.

The three-dimensional model need not be in the form of a human face. For example, the three-dimensional model may be in the form of a generic shape (e.g. a standard solid geometric or standard shape such as a sphere, spheroid, or heart), a cartoon character, an animal, a plant or flower, a fruit or vegetable, a rock or stone, an astronomical object, a vehicle, an appliance, or an anthropomorphized version of any of the above.

Typically, the shape of the three dimensional model to be mounted in the book is selected (e.g. by a manufacturer or distributor, by a parent or teacher, or by a user) in accordance with an intended user or reader of the makeup practice book. For example, the selection may depend on the age, gender, or racial or ethnic background of an intended reader, or a geographic region in which the makeup practice book is to be sold. In accordance with some embodiments of the invention, the three-dimensional model may be removable or replaceable. Alternative three-dimensional models may be made available to a user of the makeup practice book, either as part of a kit or separately. A user, or different users, of a single makeup practice book may select a three-dimensional model in according to each user's momentary preference, level of skill, or other considerations. For example, various human face models may represent faces of people of different ages or genders, or with different combinations of skin colors, eye colors, complexions, features, or blemishes.

Alternatively, the three-dimensional model may represent a body part other than a face. For example, the three-dimensional model may represent a hand or foot to which nail polish may be applied.

A three-dimensional model may be constructed of any material capable of being shaped into a suitable shape. Such materials may include, for example, plastics and polymers, plaster, ceramics, glass, metal, cardboard, paper, and wood (to be understood as including wood products such as particle board and plywood), as well as composites of the above. The material may be formed into the shape of the three-dimensional model using any suitable method known in the art. Such methods may include, for example, three-dimensional printing, die casting, molding, laser cutting, machining, carving, chiseling, or any other suitable manual or automatic shaping method known in the art.

Typically, the surface of the three-dimensional model is made of a material to which makeup may be applied and made to adhere. For example, the material may include a suitable polymer material, such as a rubber or plastic. The material may be selected so as to have a desired texture (e.g. similar to human skin) or color. The selected material may enable multiple cycles of makeup application and makeup removal (e.g. using a suitable cleansing agent, makeup removal product, or solvent) without significant deterioration of the surface. Alternatively or in addition, a used surface may be removable from the three-dimensional model and replaceable with a new surface. Replaceability of the surface of the three-dimensional model may also enable limited adaptation of the three-dimensional model surface to a particular user's requirements or preferences.

The makeup kit typically is constructed in a modular fashion with multiple compartments. Each compartment typically holds a component, or a group of similar components, of the makeup kit. The makeup kit typically includes several types of makeup and appropriate applicators. For example, the kit may include various forms of makeup in various shades (e.g. rouge, blush, eye shadow, lip gloss), and various applicators for applying makeup, whether built in to the applicator (e.g. lipstick, eyeliner pencil) or separate (e.g. brushes for applying various types of makeup from an appropriate container). Typically, various modules of the makeup kit include appropriate removable covers to prevent unintentional loss of the various components of the kit, as well as preventing unintentional staining or coloring of clothing or surfaces.

Some or all of the makeup kit may be removable, transportable, or replaceable as a whole. For example, some or all of the compartments may be mounted to a common base or may be held by a common holder (other than the book itself). Alternatively, a compartment of the makeup kit may be a separate unit that is not physically attached to any other of the compartments.

Reference is made to the accompanying figures.

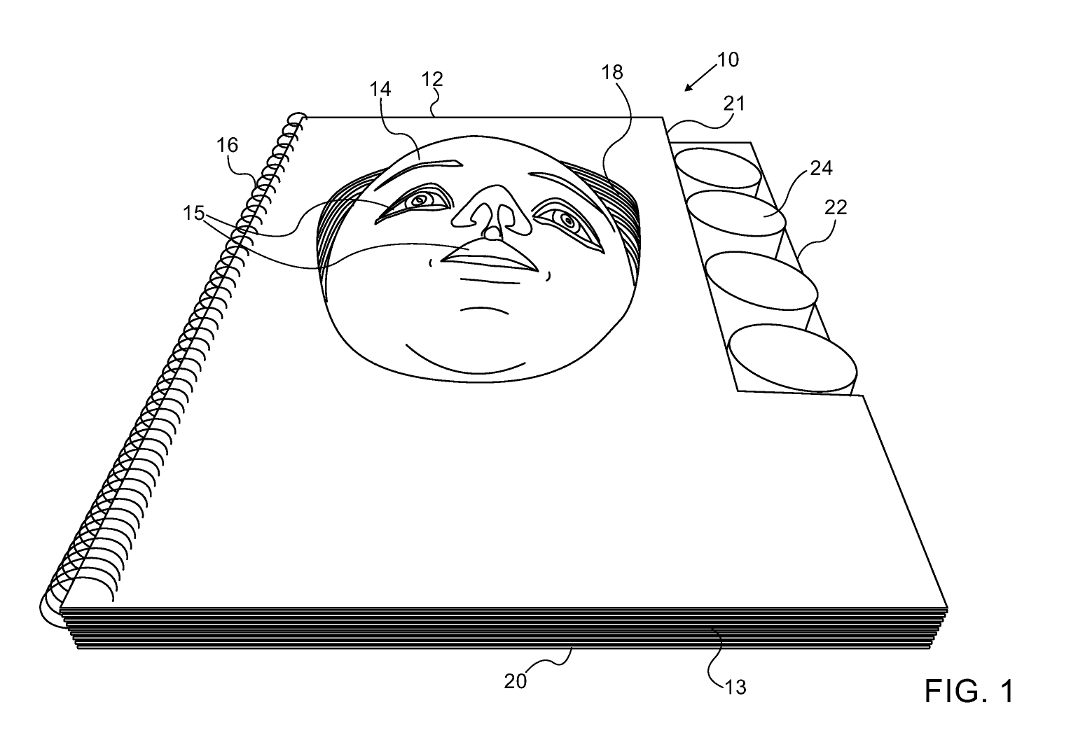

FIG. 1 shows a makeup practice book, in accordance with an embodiment of the invention, with the book closed and its front cover visible. As shown in FIG. 1, makeup practice book 10 is closed with front cover 12 facing upward. In the embodiment shown, three-dimensional model 14 is visible through model cutout section 18 in front cover 12 and in internal pages 13. Similarly, makeup kit 22 is visible through kit cutout section 21. Makeup kit 22 and three-dimensional model 14 are mounted on rear cover 20.

Front cover 12, internal pages 13, and rear cover 20 are bound together by binding 16. Binding 16 may be a metal or plastic coil binding as shown, or any other suitable binding. The binding may such as to enable front cover 12, internal pages 13, and rear cover 20 to open in a convenient manner (e.g. flat), so as not to interfere with reading the text while applying makeup to the three-dimensional model. Alternatively, the binding may include a loose-leaf type binding. Such a loose-leaf type binding may enable a user to interchange pages, such as internal pages 13, of makeup practice book 10.

Three-dimensional model 14 may be constructed with features, such as human features 15. Human features 15 (or an alternative design) may be part of an overlay of three-dimensional model 14.

Makeup kit 22 includes a modular construction with individual makeup compartments 24. Makeup kit 22 may be removable as a whole from makeup practice book 10 or may include at least a base or holder that is permanently attached. A makeup compartment 24 may be removable from makeup kit 22 or may be fixed within makeup kit 22. Thus, some or all of makeup compartments 24 may be replaceable or interchangeable. For example, a makeup compartment 24 may be replaceable when its contents are used up or lost, or in order to adapt the contents of makeup kit 22 to a user's preference. Alternatively, the modular structure of makeup kit 22 may enable a producer of makeup practice book 10 to adapt the contents of makeup kit 22 to the text of the book.

A makeup compartment 24 is typically provided with a cover. The cover may be transparent, or may contain a transparent window, such that the contents of makeup compartment 24 are visible without opening. The cover may be closed when not in use so as to prevent the contents of makeup compartment 24 from spilling out or from unintentionally coming into contact with other objects.

Alternatively to individual covers for each makeup compartment 24, makeup kit 22 may be provided with a single cover. In this case, individual makeup compartments of makeup kit 22 may be separated from one another by partitions. The single cover may be designed such that when closed, the cover cooperates with the partitions so as to prevent contents of one makeup compartment from spilling into another.

A makeup compartment 24 may contain one or more makeup substances. When a single makeup compartment 24 contains more than one makeup substance, the separate makeup substances may be held by separate trays, containers, or indentations. A makeup compartment 24 may contain one or more makeup applicators. The interior shape of a makeup compartment 24 may be configured so as to hold the applicators in place. For example, the interior may be molded with suitably shaped indentations or holders for holding the applicators place. A makeup compartment 24 may include cosmetic accessories, as artificial eyelashes of various lengths. A makeup compartment 24 may include accessories specific to makeup practice book 10. For example, a makeup compartment 24 may include replaceable components of three-dimensional model 14. Such replaceable components may include eyebrows or hair, or face components such as nose or lips, or jewelry.

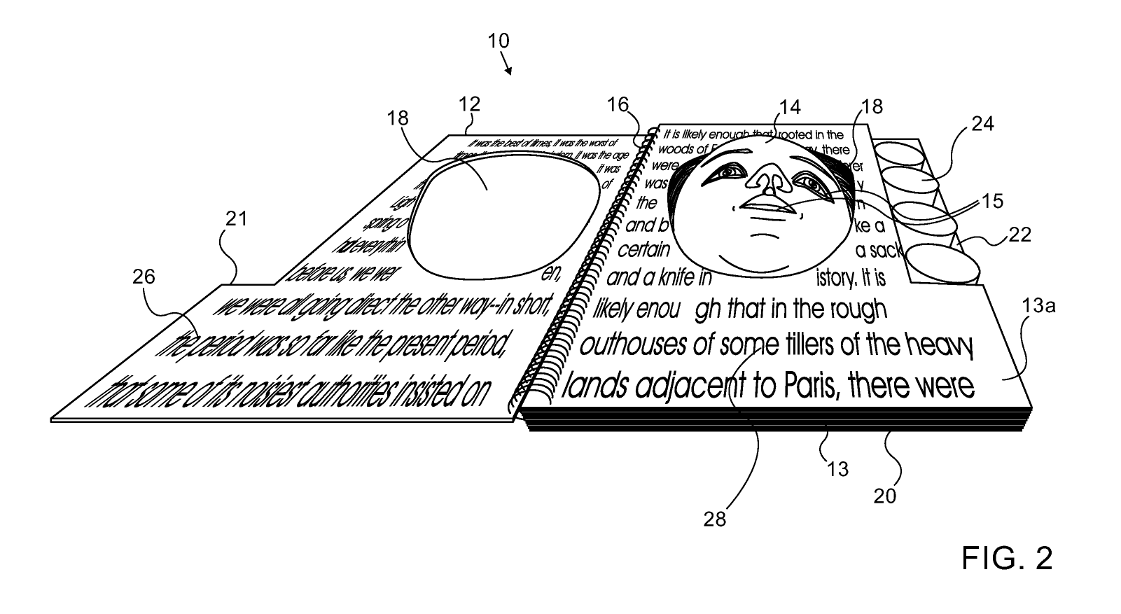

FIG. 2 shows the makeup practice book shown in FIG. 1 with the front cover opened. In FIG. 2, the inner side of front cover 12 is exposed, as well as exposed interior page surface 13a. The inner surface of front cover 12 may include text in the form of verso text 26. Exposed interior page surface 13a may include recto text 28. Verso text 26 and recto text 28 may include text in the form of, for example, alphanumeric characters, symbols, pictures, or diagrams. Verso text 26 and recto text 28 may be deposited by any suitable automatic or manual printing, drawing, impressing, or coloring method known in the art (the verso and recto texts actually shown in the accompanying figures figure are given for illustration purpose only).

As shown in FIG. 2, three-dimensional model 14 is accessible via model cutout section 18, and makeup kit 22 is accessible via makeup kit cutout section 21.

The contents of verso text 26 and recto text 28 may include a single continuous narrative. Alternatively, the contents may differ. For example, one of verso text 26 or recto text 28 may include a segment of a story or narrative. The other of verso text 26 or recto text 28 may include instructions for applying makeup from makeup kit 22 to three dimensional model 14. For example, instructions may include directions for applying contents of one or more makeup compartments 24 to a human feature 15.

The type of content of verso text 26 and of recto text 28 may vary from page to page of makeup practice book 10. Typically, verso text 26 and recto text 28 are related in their content.

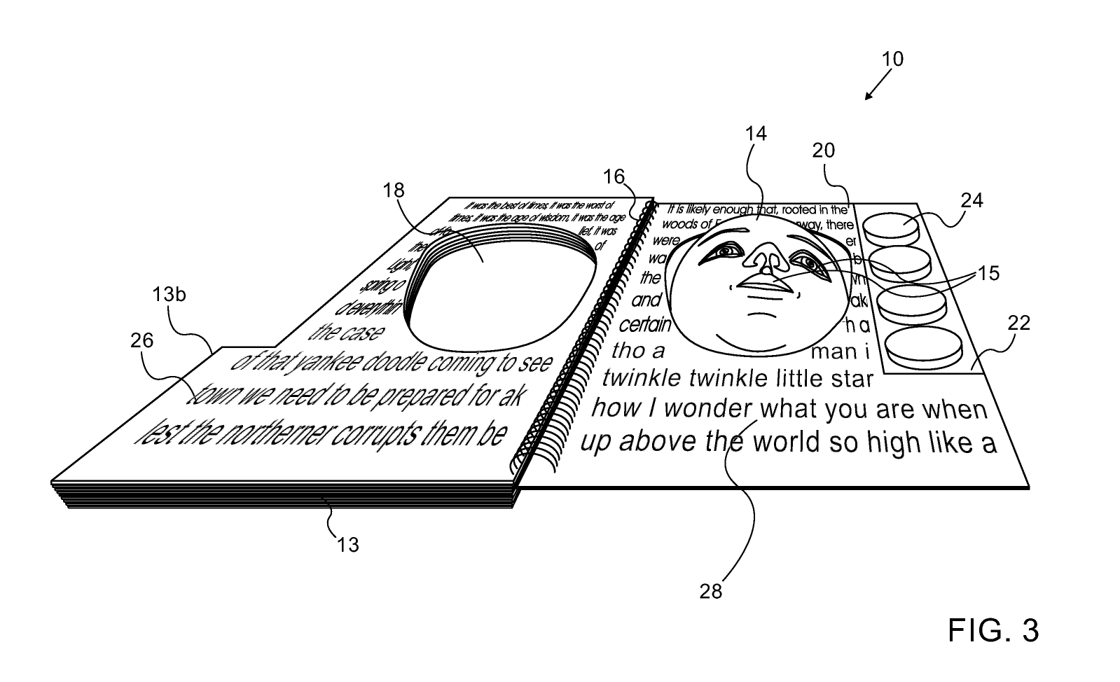

FIG. 3 shows the makeup practice book shown in FIG. 1, opened to the inside of the back cover. Back cover 20 may be printed with recto text 28. Three-dimensional model 14 and makeup kit 22 are mounted to back cover 20.

In accordance with an embodiment of the present invention, three-dimensional model 14 may be detachable from back cover 20. In this manner, three-dimensional model 14 may be replaced with another one in accordance with instructions in a text of makeup practice book 10, or in accordance with a user's preference. Alternatively, an overly that includes human features 15 may be removed from three-dimensional model 14 and replaced with another overlay. Replacing three-dimensional model 14 or its overlay may enable the user to read or follow instructions of makeup practice book 10 another time with different effect. For example, replacing a face depicted by three-dimensional model 14 or its overlay with another having a different complexion or appearance may enable the user to practice applying makeup to a different face.

In accordance with an embodiment of the present invention, makeup kit 22, or its component makeup compartments 24, may be detachable from back cover 20. Thus, makeup kit 22 or one or more of makeup compartments 24 may be replaced. For example, makeup kit 22 or a makeup compartment 24 may be replaced with its contents are used up, in order to adapt makeup kit 22 to instructions on a particular page of makeup practice book 10, or in order to adapt makeup kit 22 to a particular face depicted by three-dimensional model 14.

In accordance with an embodiment of the present invention, rather than a being attached to back cover 20, three-dimensional model 14, makeup kit 22 (or one or more of makeup compartments 24), or both, may be attached to an internal page or divider of a makeup practice book. Such a book may enable one face to be displayed in one section of the book, and a different face to be displayed in a different section (e.g. chapter) of the book.

For example, consider a book with pages divided by a divider into a front section and a rear section (the divider may also include text). Each of the sections is provided with a separate three-dimensional model. A rear model that is mounted to the inside of the back cover of the book may extend, when the book is closed, through cutout sections in internal pages of the rear section of the book. A front model may be mounted on a side of the divider that faces the front of the book. When the book is closed, the front model may extend through cutout sections in the pages of the front section of the book. If the height of the rear model is less than (or approximately equal to) the thickness of the pages of the rear section, no cutout may be necessary in the divider. However, if the height of the rear model is greater than the thickness of the pages of the rear section, the divider is provided with a cutout suitable for accommodating at least the front-facing section of the rear model. In this case, a rear-facing section of the front model may also be made at least partially hollow so as to accommodate at least the front-facing section of the rear model.

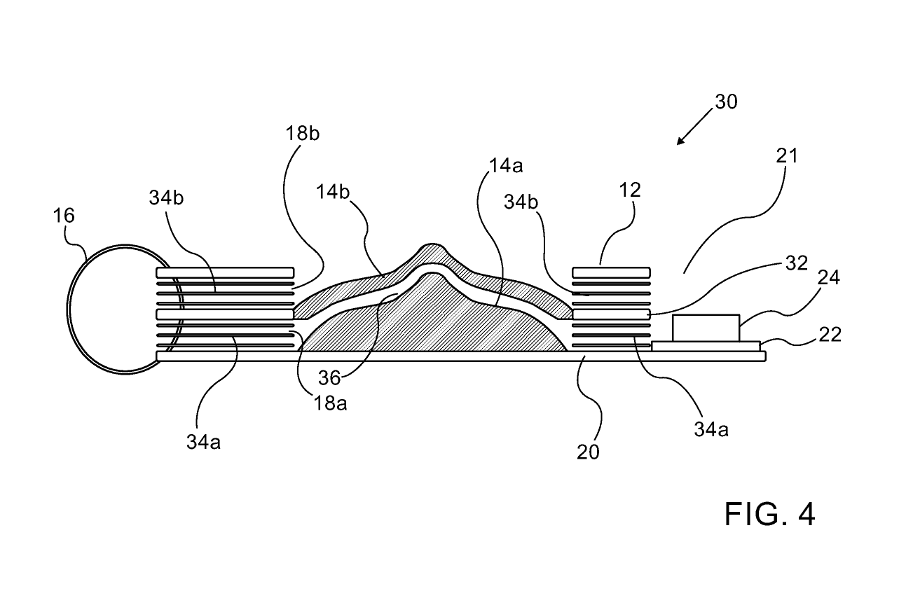

In accordance with some embodiments of the invention, three-dimensional models attached to different pages of a makeup practice book may nest inside one another when the makeup practice book is closed. FIG. 4 shows a cross section of a makeup practice book that includes nested three-dimensional models, in accordance with an embodiment of the invention.

Nested model makeup practice book 30 includes a rear model 14a mounted to inward facing side of back cover 20. A second three-dimensional model, front model 14b, is attached to a side of divider 32 that faces front cover 12 of nested model makeup practice book 30.

Divider 32 separates the pages of nested model makeup practice book 30 into rear pages 34a and front pages 34b. Each page of rear pages 34a includes cutout section 18a for accommodating rear model 14a. Similarly, each page of front pages 34b, as well as front cover 12, includes cutout section 18b for accommodating front model 14b. Rear pages 34a and front pages 34b include makeup kit cutout section 21 for enabling access to makeup kit 22.

Front model 14b is at least partially hollow on its side that faces rear cover 20, in the form of cavity 36. Cavity 36 is of such size and shape so as to accommodate at least a front portion of rear model 14a. Thus, when nested model makeup practice book 30 is closed, as shown in FIG. 4, rear model 14a at least partially extends into cavity 36.

In the same manner, a makeup practice book may include more than two models. Additional three-dimensional models may be mounted on additional dividers within the book.

Each section of the book may be provided with a separate makeup kit (e.g. mounted on each divider to which a three-dimensional model is mounted). The contents of each section's makeup kit may be adapted to that section's three-dimensional model or to the text in that section. Alternatively, a single makeup kit may be provided for several or all of the sections. In this case, some or all of the dividers may include appropriate cutout sections to enable access to the makeup kit from the appropriate sections of the makeup practice book.

In accordance with an embodiment of the present invention, the three-dimensional model may be mounted on the inside of a front cover of the makeup practice book (or on a rear-facing side of an internal divider). In this case, the book must be opened in order for the three-dimensional model to be visible. Subsequent pages of the book may be provided with cutout sections so as to enable access to the three-dimensional model from interior pages of the book. The makeup kit may be mounted on the inside of the front cover together with the three-dimensional model, or on the inside of the rear cover (or on a divider).

In accordance with an embodiment of the present invention, some or all of the interior pages of the makeup practice book may be provided with an overlay. The overlay of each page may be mounted over the cutout in that page. For example, when a three-dimensional model is mounted on the inside of the back cover, turning pages of the book in order may remove an overlay from the three-dimensional model. Removing the overlay may either expose a lower (closer to the three-dimensional model) overlay, or expose the three-dimensional model. The overlays may be designed to nest into one another. As another example, the three-dimensional model may be mounted to the inside of the front cover. In this case, turning pages in order may add additional overlays over the three-dimensional model (and lower overlays).

In this manner, as pages of the book are turned, different surfaces are exposed such that makeup may be applied to them. For example, the overlays may be opaque, such that turning pages exposes a completely different surface to the user. As another example, the overlays may be made of a thin (but sufficiently stiff or strong to resist wrinkling or tearing) transparent material. In this case, and for a three-dimensional model that is mounted to the inside of the front cover, a user may apply different types of makeup to the different overlays. The lower overlays layers to which makeup had been previously applied may then be visible through the topmost overlay.

If the makeup practice book is provided with a loose-leaf type binding, pages to which overlays are mounted may be replaceable. For example, each page to which an overlay is mounted may include text that is relevant to that overlay.

In accordance with embodiments of the present invention, a makeup practice book may be provided with a case. The case may be provided with a handle to enable carrying the case. The case may be designed to hold, in a secure manner, the makeup practice book and any accessories. Such accessories may include, for example, additional three-dimensional models (for an embodiment that includes interchangeable three-dimensional models), additional overlays for the three-dimensional model (for an embodiment that includes interchangeable overlays), additional makeup kits (for an embodiment that includes interchangeable makeup kits), or additional makeup compartments.

In accordance with embodiments of the present invention, a makeup practice book may be provided as part of a kit. A kit may include, in addition to the makeup practice book, one or more of the following: alternative three-dimensional models, alternative overlays for three-dimensional models, alternative makeup kits, alternative makeup compartments, material for preparing an alternative three-dimensional model or overlay, makeup removal equipment and substances, alternative pages, blank pages on which additional content may be printed, a carrying case or bag, supplementary educational materials, or an instruction book. A kit may include appropriate data storage media. For example, such storage media may include: additional instructions or supplementary material in one or more formats (e.g. text, audio, or video), content for enabling printing of additional or replacement pages, and associated computer games.

1. A makeup practice book comprising:
a three-dimensional model mounted on a bound page of the book, the model including a surface to which a makeup substance may be applied;
at least one compartment provided on a bound page of the book for holding a makeup substance that may be applied to the surface; and
one or more bound pages of the book that are adjacent to the page on which the model is mounted, each page of said one or more bound pages including a cutout section that is aligned to the model, such that the surface is accessible via the cutout section when the book is open to a page of said one or more bound pages.

2. A makeup practice book as claimed in claim 1, wherein the bound page to which the model is mounted or on which the compartment is provided is a cover of the book.

3. A makeup practice book as claimed in claim 2, wherein the cover is a back cover.

4. A makeup practice book as claimed in claim 1, wherein at least one of the following is removable and attachable: a bound page of the book, the model, the surface and the compartment.

5. A makeup practice book as claimed in claim 1, wherein the model depicts a human face.

6. A makeup practice book as claimed in claim 1, wherein the surface comprises a polymer material.

7. A makeup practice book as claimed in claim 1, comprising a compartment for holding a makeup applicator, the compartment being provided on a bound page of the book.

8. A makeup practice book as claimed in claim 1, wherein the three dimensional model comprises a material selected from a group of materials consisting of: polymer, plaster, ceramics, glass, metal, cardboard, paper, wood and wood products.

9. A makeup practice book as claimed in claim 1, wherein the three dimensional model is produced by a technique selected from a group of techniques consisting of:
three dimensional printing, die casting, molding, and laser cutting.

10. A makeup practice book as claimed in claim 1, wherein the surface is accessible via a cover of the book when the book is closed.

11. A makeup practice book as claimed in claim 1, the book comprising another three dimensional model that is mounted on a page of said one or more bound pages.

12. A makeup practice book as claimed in claim 11, wherein the other model includes a cavity such that when the book is closed, at least a portion of the three dimensional model extends into the cavity of the other model.

13. A makeup practice book as claimed in claim 11, wherein the page from which the other model extends is a divider of the book.

14. A makeup practice book as claimed in claim 1, wherein the book is part of a kit.

15. A makeup practice book as claimed in claim 14, wherein the kit includes an additional component selected from a group of kit components consisting of: a three-dimensional model, a compartment, makeup removal equipment, a page, a carrying case, an instruction book and a data storage medium.
